(19) United States
(12) Patent Application Publication
(10) Pub. No.: US 2005/0117718 A1
(43) Pub. Date: Jun. 2, 2005

(54) Direct-dial message center for touchtone telephone

(76) Inventor: Lisa Tara Elkan, Encino, CA (US)

Correspondence Address: Lisa Tara Elkan, 4612 Hayvenhurst Ave., Encino, CA, 91436, US

(21) Appl. No.: 10/724,548

(22) Filed: Nov. 28, 2003

(51) Int. Cl. H04M 1/64

(52) U.S. Cl. 379/88.22; 379/67.1

(57) ABSTRACT

A direct-dial message center function for cellular and landline telephones, which provides an effortless and convenient alternative for the user to leave a telephone message. A user of the direct-dial message center can leave a message for a person, using a code plus the other person's regular phone number, knowing that will not have to talk if they don't want to, or if they don't have the time. Thus a considerably more useful message center service is provided—that allows the user the freedom of mind to know that by using one simple code in addition to the main phone number, they can leave a message without the possibility of talking to the person.

### CROSS-REFERENCE TO RELATED APPLICATONS

Not Applicable.

### FEDERALLY SPONSORED RESEARCH

Not Applicable.

### SEQUENCE LISTING

Not Applicable.

### BACKGROUND OF THE INVENTION—FIELD OF INVENTION

This invention relates to touchtone telephones, specifically to the message center or voice mail feature, which is used to leave people messages.

### BACKGROUND OF THE INVENTION

Currently, there are several ways to receive messages. First, landline telephone users may purchase an answering machine for the home or office. Second, cellular phone users may pay to have a voice mail feature on their phone, which allows the phone to take messages if the person does not answer it when someone calls. Third, both landline and cellular phone users may pay an independent message center a monthly fee to rent a phone number specifically for receiving messages.

When one person calls another person who has either an answering machine for their landline telephone or a voice mail feature for their cellular phone, the call is answered or the caller has the option of leaving a message. However, there are times when a caller would just like to leave a brief message because he or she does not have time to talk, does not wish to talk, does not want to bother the person being called, or does not want to use his or her minutes, which can be expensive.

### BACKGROUND OF INVENTION—OBJECTS AND ADVANTAGE

Several objects and advantages of the present invention are:

(a) to provide a way to leave a message

(b) to utilize a system that has been successful thus far

Further objects and advantages are to provide a message center system that can be dialed directly from any touchtone phone, using the previously-existing phone numbers of message center or voice mail subscribers, which is easy-to-use, cost-saving, and time-efficient. Still further objects and advantages will become apparent from a consideration of the ensuing description and drawing.

### SUMMARY

The invention, a new message center feature for touchtone telephones, allows the user to dial a code (i.e. *99), followed by the phone-number of the person they wish to call, and be automatically forwarded to the person's message center.

Accordingly several objects and advantages of the invention are to provide a quicker, more efficient system of leaving messages by eliminating talking time if you do not have time to talk, do not feel like talking, do not wish to disturb the person; or simply need to leave a piece of information for the person. Also, this invention would be an investment both for the user and for the phone company. For the user, it could eliminate unnecessary fees for minutes used talking. For the phone company, it is another feature that they could increase their business. Still further objects and advantages will become apparent from a study of the following description and the accompanying drawing.

### DRAWINGS—FIGURES

In the drawing, closely related figures have the same numbers but different alphabetical suffixes.

FIG. 1A represents the caller's telephone.

FIG. 1B represents the callee's telephone.

FIG. 2B represents the callee's answering machine or voice mail.

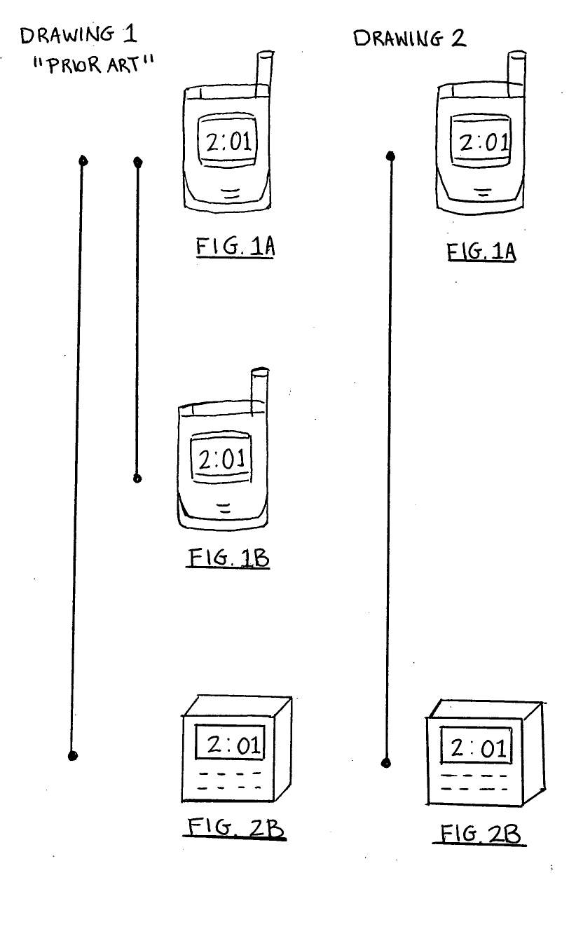

### OPERATION

In Drawing 1, the illustration represents the caller using the cellular or landline phone without the “Direct-Dial Message Center for Touchtone Telephone” feature. The caller may either reach the callee, phone to phone, or the callee's answering service, phone to answering service, depending on whether or not the callee answers his or her phone.

The callee's phone is answered with a recording of the callee's voice, or any voice, music, advertisement, or message the callee chooses.

In Drawing 2, the illustration represents the caller using the cellular or landline phone with the “Direct-Dial Message Center for Touchtone Telephone” feature. The caller can, when desired, leave a message for the callee without having to disturb him or her. This can be achieved by dialing a code (i.e. *99), followed by the phone-number of the callee, and be automatically forwarded to the callee's message center.

Advantages

From the description above, a number of advantages of my “Direct-Dial Message Center for Touchtone Telephone” become evident:

(a) A caller may leave a message for a callee without disturbing the callee.

(b) A caller may leave a message for a callee if he or she is in a hurry and does not have the time to talk.

(c) A caller may leave a message for a callee if he or she wishes to give the callee a piece of information, but does not need to converse.

(d) A caller may leave a message for a callee if he or she would like to save money on call minutes.

### CONCLUSION, RAMIFICATIONS, AND SCOPE OF INVENTION

Thus the reader will see that the direct-dial feature of the invention provides a highly efficient, cost-effective, useful, and convenient alternative to the current message-center options that can be accessed using a touchtone telephone.

While my above description contains much specificity, this should not be construed as a limitation on the scope of the invention, but rather as an exemplification of one preferred embodiment thereof. There are other possible variations.

Accordingly, the scope of the invention should be determined not by the embodiment illustrated, but by the appended claims and their legal equivalents.

1. A method for leaving a message using a touchtone cellular or landline telephone and any telephone company service, comprising the steps of:
(a) utilizing a code (i.e. *99), plus an already-existing phone number to direct-dial a callee's message center
(b) providing that the callee subscribes to my service through the telephone company
